(19) United States
(12) Patent Application Publication
(10) Pub. No.: US 2008/0254818 A1
(43) Pub. Date: Oct. 16, 2008

(54) Method, Communication System and Communication Unit for Protecting Incumbent Wireless Services

(75) Inventor: Gunnar Nitsche, Radebeul (DE)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/995,562

(22) PCT Filed: Jul. 3, 2006
(86) PCT No.: PCT/IB06/52230

§ 371 Date: Jan. 14, 2008

(30) Foreign Application Priority Data
Jul. 12, 2005 (EP) 05015063.0

(51) Int. Cl. H04Q 7/20

(52) U.S. Cl. 455/501

(57) ABSTRACT

The invention relates to a Method, a Communication System and an Communication Unit for protecting incumbent services whereas in the incumbent services first information is exchanged between first communication means by radio frequency transmission within a first bandwidth using a first protocol and second information is exchanged between second communication means by radio frequency transmission within a second bandwidth using a second protocol and the second bandwidth is overlapping and larger than the first bandwidth. The problem to be solved is to reduce or to eliminate an interference of secondary services to incumbent services. The problem is solved by ascertaining the presence of any first information exchange between said first communication means; transmitting a protecting information at least about the presence of a first information exchange to at least one of the second communication means; inhibiting said at least one of the second communication means to use the radio frequencies used for exchanging the first information for transmitting the second information and transmitting the second communication within a frequency range wherein the radio frequencies used for exchanging the first information for transmitting the second information are notched.

The invention relates to a Method for protecting incumbent services whereas in the incumbent services first information is exchanged between first communication means by radio frequency transmission within a first bandwidth using a first protocol and second information is exchanged between second communication means by radio frequency transmission within a second bandwidth using a second protocol and the second bandwidth is overlapping and larger than the first bandwidth.

The invention relates also to a Communication system for protecting incumbent services whereas a incumbent service uses first communication means for exchanging first information by radio frequency transmission within a first bandwidth using a first protocol and whereas the communication system includes second communication means for exchanging second information between second communication means by radio frequency transmission within a second bandwidth using a second protocol and the second bandwidth is overlapping and larger than the first bandwidth.

The invention further relates to a Communication unit for protecting incumbent services whereas a incumbent service uses first communication means for exchanging first information by radio frequency transmission within a first bandwidth using a first protocol and for communication with a second information exchange between second communication means as one of the communication means for exchanging second information between second communication means by radio frequency transmission within a second bandwidth using a second protocol and the second bandwidth is overlapping and larger than the first bandwidth.

New wireless applications (so-called secondary services) are coming up that reuse spectrum that is already allocated for other applications, the so-called incumbent (or primary) services. Examples are WLAN (Wireless LAN) in the 5 GHz band and UWB (Ultra Wideband). Since the incumbent services are typically licensed and the new application license exempt, the former need to be protected from interference by the latter. This is particular complicated for UWB, which may operate from 3.1 to 10.6 GHz, since many incumbent services may be affected.

The US Patent Application 2004/0199686 A1 relates to a wireless communication of communication devices within a piconet. Particularly it relates for avoiding an interference of competing devices within the piconet. This publication does not solve the above mentioned problem.

The US Patent Application 2005/0083896 A1 describes the coexistence of multiple piconets such as UWB. This description does not eliminate any interference to other nets or wireless services.

The GB Patent 2399475 A relates to avoidance of interference between cellular phone network and UWB. This is solved by a time division.

A scheme to distribute regulatory information such as allowed channels and maximum transmit power is described in IEEE 802.11d-2001: Specification for Operation in Additional Regulatory Domains (http://standards.ieee.org/getieee802/download/802.11d-2001.pdf).

A scheme to protect radars, which are important incumbent services in the 5 GHz band, from WLAN interference, is described in IEEE 802.11h-2003: Spectrum and Transmit Power Management Extensions in the 5 GHz band in Europe (http://standards.ieee.org/getieee802/download/802.11h-2003.pdf).

The MBOA proposed UWB system is described in IEEE P802.15-04/0493r1: “Multi-band OFDM Physical Layer Proposal for IEEE 802.15 Task Group 3a” (ftp://ieee:wireless@ftp.802wirelessworld.com/15/04/15-04-0493-01-003a-multi-band-ofdm-cfp-document-update.zip).

In order to obtain a useful range, UWB systems need to operate at transmit power levels (the FCC allows −41.3 dBm/MHz) that might cause interference to incumbent services in certain situations.

The problem to be solved is to reduce or to eliminate an interference of secondary services to incumbent services.

The problem is solved by a method according to claim 0. Preferred versions of the method are claimed in claims 2 to 10.

The problem is also solved by a communication system according to claim 11. Preferred embodiments of the communication system are claimed in claims 12 to 20.

The problem is also solved by a communication unit according to claim 21. Preferred embodiments are claimed in claims 22 to 29.

In order to obtain a useful range secondary services for exchanging first information need to operate at transmit power levels that might cause interference to incumbent services exchanging second information in certain situations.

Typically, the secondary service uses a bandwidth that is multiple larger than the incumbent service, so the interference can be much reduced if the secondary service avoids to transmit in the small band used by the incumbent service (notching), without significant reduction of the secondary service performance.

A problem is to know which frequencies have to be notched. The autodetection of some incumbent services, e.g. the downlink of fixed wireless access, is very difficult due to the low receiving signal levels.

This invention overcomes the autodetection problem by introducing a new signalling scheme that is used to “tell” second communication means which frequencies have to be notched. It is assumed that at least one of the second communications means, e.g. in a UWB piconet, is rather stationary, e.g. a PC or TV set, so it is able to know the local incumbent services to be protected and it distributes this information to the other second communication means.

It is expected that at least one of the second communication means “knows” the protection information. Possibilities where this knowledge is coming from are factory configuration, autodetection or hand configuration by the user.

In the following the invention is described by an example. In the drawings shows

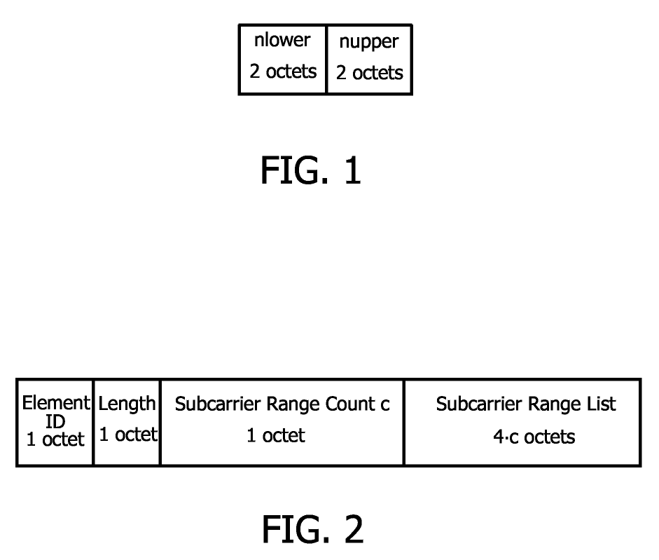

FIG. 1 a Subcarrier range format and FIG. 2a 2—Protection Information Element format.

For sencondary services there are several UWB protocols proposed. This invention is applicable to all of these.

As example embodiment, the WiMedia/MBOA MAC protocol is chosen (MBOA Draft MAC Standard 0.95, Apr. 11, 2005).

In section 7.8 of this standard, several information elements (IEs) are specified that may be present in management frames. In order to implement this invention, a new IE “Protection IE” has to be added, which shall be used in Beacon and Probe Response frames if protection information is available.

Since WiMedia/MBOA is based on OFDM, it is preferable to specify frequency ranges in OFDM subcarrier numbers instead of absolute frequencies as shown in FIG. 1. The frequency (f)/subcarrier (n) relation can be defined as

f=3168 MHz+n*4.125 MHz, where n=0, 1, . . . , 1792.

Subcarriers from nlower to nupper shall be nulled (notched).

For non-OFDM systems, it is preferable to specify frequency ranges in absolute frequencies.

FIG. 2 shows a 2-Protection Information Element format. The terminal as communication means receiving this Information Element shall avoid transmitting on all subcarrieres specified in the Subcarrier Range List.

A possible Protection Information Element format is given in FIGS. 1 and 2.

A further advantage of this invention is that the notching information can also be used by the receiver, which can improve its decoding performance by ignoring the notched subcarriers.

A major application for UWB is expected to be WUSB, the wireless extension of USB. As wired USB, this application is PC centric, so in many cases it will be controlled by a stationary desktop PC, which is likely to know the local incumbent services to be protected.

1. Method for protecting incumbent services whereas in the incumbent services first information is exchanged between first communication means by radio frequency transmission within a first bandwidth using a first protocol and second information is exchanged between second communication means by radio frequency transmission within a second bandwidth using a second protocol and the second bandwidth is overlapping and larger than the first bandwidth comprising
ascertaining the presence of any first information exchange between said first communication means;
transmitting a protecting information at least about the presence of a first information exchange to at least one of the second communication means;
inhibit said at least one of the second communication means to use the radio frequencies used for exchanging the first information for transmitting the second information and
transmitting the second communication within a frequency range wherein the radio frequencies used for exchanging the first information for transmitting the second information are notched.

2. Method according to claim 1 wherein the protecting information is placed and transmitted within the second protocol.

3. Method according to claim 1 wherein the protecting information is transmitted from one of the second communication means to the other second communication means.

4. Method according to claim 1 wherein said one of the second communication means is a stationary station.

5. Method according to claim 1 further comprising:
assessing the radio frequencies used for the first information exchange and
transmitting the assessed result as protecting information.

6. Method according to claim 1 wherein the inhibited frequencies are predetermined within the at least one of the second communication means and are selected corresponding to the protecting information.

7. Method according to claim 1 wherein the inhibited frequencies are autodetected by one of the second communication means.

8. Method according to claim 1 wherein the inhibited frequencies are adjusted by the user of one of the second communication means.

9. Method according claim 1 wherein the second information exchange is carried out in Ultra Wideband.

10. Method according to claim 1 wherein the second information exchange is carried out in WLAN.

11. Communication system for protecting incumbent services whereas a incumbent service uses first communication means for exchanging first information by radio frequency transmission within a first bandwidth using a first protocol and whereas the communication system includes second communication means for exchanging second information between second communication means by radio frequency transmission within a second bandwidth using a second protocol and the second bandwidth is overlapping and larger than the first bandwidth comprising
means for ascertaining the presence of any first information exchange between said first communication means;
means for transmitting a protecting information at least about the presence of a first information exchange to at least one of the second communication means;
at least one of the second communication means provided with means for inhibiting the usage of the radio frequencies used for exchanging the first information for transmitting the second information and
second communication means transmitting the second communication within a frequency range wherein the radio frequencies used for exchanging the first information for transmitting the second information are notched.

12. Communication system according to claim 11 wherein the second means are processing the second protocol wherein the protecting information is included and transmitted within the second protocol.

13. Communication system according to claim 11 wherein the protecting information is transmitted from one of the second communication means to the other second communication means.

14. Communication system according to claim 11 wherein said one of the second communication means is a stationary station.

15. Communication system according to claim 11 further comprising:
assessing the radio frequencies used for the first information exchange and
transmitting the assessed result as protecting information.

16. Communication system according to claim 11 wherein the frequencies of the first information exchange are predetermined within the at least one of the second communication means and to be selected as inhibited frequencies corresponding to the protecting information.

17. Communication system according to claim 11 wherein at least one of the second communication means is provided with means for autodetecting the inhibited frequencies.

18. Communication system according to claim 11 wherein at least one of the second communication means is provided with means for adjusting the inhibited frequencies by the user.

19. Communication system according to claim 11 wherein the second communication means are members of Ultra Wideband.

20. Communication system according to claim 11 wherein the second communication means are members of WLAN.

21. Communication unit for protecting incumbent services whereas a incumbent service uses first communication means for exchanging first information by radio frequency transmission within a first bandwidth using a first protocol and for communication with a second information exchange between second communication means as one of the communication means for exchanging second information between second communication means by radio frequency transmission within a second bandwidth using a second protocol and the second bandwidth is overlapping and larger than the first bandwidth including means for inhibiting the usage of the radio frequencies used for exchanging the first information for transmitting the second information and means transmitting the second communication within a frequency range wherein the radio frequencies used for exchanging the first information for transmitting the second information are notched.

22. Communication unit according to claim 21 provided with means for ascertaining the presence of any first information exchange between said first communication means and means for transmitting a protecting information at least about the presence of a first information exchange to at least one of the second communication means.

23. Communication unit according to claim 21 processing the second protocol wherein the protecting information is included and transmitted within the second protocol.

24. Communication unit according to claim 21 comprising;
assessing the radio frequencies used for the first information exchange and
transmitting the assessed result as protecting information.

25. Communication unit according to claim 21 wherein the frequencies of the first information exchange are predetermined within the at least one of the second communication means and to be selected as inhibited frequencies corresponding to the protecting information.

26. Communication unit according to claim 21 wherein at least one of the second communication means is provided with means for autodetecting the inhibited frequencies.

27. Communication unit according to claim 21 wherein at least one of the second communication means is provided with means for adjusting the inhibited frequencies by the user.

28. Communication unit according to claim 21 whereas the communication unit is formed as a member of Ultra Wideband.

29. Communication unit according to claim 21 whereas the communication unit is formed as a member of WLAN.
